(19) United States
(12) Patent Application Publication
(10) Pub. No.: US 2016/0073288 A1
(43) Pub. Date: Mar. 10, 2016

(54) REDUCING CONTENTION IN A PEER-TO-PEER DATA LINK NETWORK

(71) Applicant: QUALCOMM Incorporated, San Diego, CA (US)

(72) Inventors: Abhishek Pramod Patil, San Diego, CA (US); Amin Jafarian, Princeton, NJ (US); George Cherian, San Diego, CA (US); Santosh Paul Abraham, San Diego, CA (US)

(21) Appl. No.: 14/848,131

(22) Filed: Sep. 8, 2015

Related U.S. Application Data
(60) Provisional application No. 62/181,976, filed on Jun. 19, 2015.
(60) Provisional application No. 62/048,113, filed on Sep. 9, 2014.

(51) Int. Cl. H04W 28/02; H04W 68/02; H04W 72/12

(52) U.S. Cl. CPC H04W 28/0289; H04W 72/1252; H04W 68/02

(57) ABSTRACT

Methods, systems, and devices are described for improving system throughput by reducing contention in a peer-to-peer (P2P) data link network. Specifically, the present disclosure provides a method of ordering data transmissions in a data transmission window based on an order of traffic announcement messages in a corresponding paging window. Moreover, a wireless station of the P2P data link network may reserve portions of a shared wireless medium for transmissions of other wireless stations belonging to the same P2P data link network and preventing transmission of out-of-network wireless stations.

### CROSS REFERENCES

The present Application for Patent claims priority to U.S. Provisional Patent Application No. 62/048,113 by Patil et al., entitled “Reducing Contention in a Mesh Network,” filed Sep. 9, 2014, and U.S. Provisional Patent Application No. 62/181,976 by Patil et al., entitled “Reducing Contention In A Data Link Network,” filed Jun. 19, 2015, assigned to the assignee hereof, and expressly incorporated by reference herein.

### BACKGROUND

The following relates generally to wireless communication, and more specifically to reducing contention in a network, such as a data link network or a peer-to-peer (P2P) network. Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems.

A wireless network, for example a wireless local area network (WLAN), may include an access point (AP) that may communicate with one or more station (STAs) or mobile devices. The AP may be coupled to a network, such as the Internet, and may enable a mobile device to communicate via the network (and/or communicate with other devices coupled to the access point). A wireless device may communicate with a network device bi-directionally. For example, in a WLAN, a STA may communicate with an associated AP via downlink (DL) and uplink (UL). The DL (or forward link) may refer to the communication link from the AP to the station, and the UL (or reverse link) may refer to the communication link from the station to the AP.

Therefore, a wireless multiple-access communications system may include a number of access points, each simultaneously supporting communication for multiple mobile devices or nodes. However, deploying large number of base stations or access points with wired infrastructure may not be cost effective. An alternative to the traditional method of wireless communication includes a wireless mesh or P2P network where mobile devices (and other wireless communication devices) may form networks without base stations, access points or equipment other than the mobile devices themselves.

Wireless data link networks or P2P networks are dynamically self-organized and self-configured with stations in the network automatically establishing an ad-hoc network with other stations such that the network connectivity is maintained. In a P2P network topology, each STA or node relays data for the network and all stations cooperate in the distribution of data within the network. As a result, a message in the P2P network is transmitted from a provider station to the destination station by being propagated along a path, hopping from one STA to the next until the destination is reached. However, in a congested network, stations that have traffic for transmission may experience contention from multiple stations on the network challenging for the limited medium resources. Conventional methods of resolving contentions may include preventing either station from utilizing the medium during the collision period. As a result, contentions may adversely affect resourceful utilization of the transmission medium.

### SUMMARY

The present disclosure may relate generally to a wireless communication system, and more particularly to improved systems, methods, and/or apparatuses for reducing contention in a data link network or P2P network, and thus increase the system throughput. In particular, the present disclosure is directed to a provider station or node transmitting a traffic announcement message associated with a particular order or sequence during a paging period or window. The order of sequence of the traffic announcement message may correspond to the order in which the particular node captures the medium during the paging window. In some examples, the traffic announcement messages may include a resource field that identifies resources of the medium that are reserved for communications. The traffic announcement message may identify at least one receiver station and indicate that the transmitter station has pending data for transmission to at least one receiver station.

Optionally, the receiver station(s), in response to receiving the traffic announcement messages, may transmit an acknowledgment message to the transmitting station during the paging period, or at the beginning of a data transmission period, acknowledging reception of the traffic announcement message. Additionally or alternatively, the receiver station(s) may transmit a trigger message to the transmitting station during the data transmission period. The trigger message may comprise an indication that the receiver station is awake, or in an active state, and available to receive data during the data transmission window. The transmitting station(s) may transmit data in the data transmission window in an order that corresponds to the order in which they transmitted their respective traffic announcement message during the paging window.

In some cases, at least one paging message, or traffic announcement, may be transmitted with an access category corresponding to the traffic type, or may carry a traffic category, such as a quality of service (QoS) type. At times, the paging message or traffic announcement may be transmitted with an access category corresponding to the traffic type and may contain a traffic category. The access category and/or traffic category may influence the order in which the data is sent during the data transmission window. For example, the data transmission window may be divided such that traffic with a higher category (e.g., voice, video, etc.) is transmitted before traffic with a lower category (e.g., background traffic). In some cases, the access category or traffic category may influence the order in which the data is sent, without dividing the data transmission window. For example, the receiver station may send trigger messages with the same access category as the traffic (e.g., the transmitted access category of the paging message or traffic announcement or the traffic category contained therein). Trigger messages with different access categories may have inherent priorities. As such, a trigger for voice traffic may be prioritized over a trigger for background traffic. A transmitter station with higher priority traffic may receive feedback (e.g., the trigger message) before, or otherwise receive a higher priority trigger message than, a transmitter station with lower priority traffic, and may therefore transmit higher priority traffic prior to transmission of the lower priority traffic. The data transmissions may be ordered without dividing or slotting the paging window or the data window, as prioritization and order may occur based on the traffic type. Thus, the present disclosure provides a method of providing ordered data transmissions via the shared medium during the data transmission window.

Additionally or alternatively, the present disclosure also provides a method of reducing contention in a P2P network by one transmitter station reserving the shared medium for use by other transmitting stations during the transmission window. Reservation of the shared medium during the transmission window (e.g., the paging window and/or the data transmission window) may allow in-network nodes to communicate while preventing out-of-network nodes from communicating during the transmission window. In one example, the transmitting station may identify the transmission window and transmit a first message (e.g., clear-to-send (CTS) message) that includes a reservation field identifying the reserved resource for the remaining portion of the transmission window. The first message may also include an identifier of the direct wireless communication link such that member nodes (i.e., nodes belonging to the same direct wireless communication link, may determine that the reserved resources are available for their use during the remaining portion of the transmission window. Thus, the present disclosure further reduces contention in the transmission window by capturing the shared medium for use by member nodes during the data transmission window.

Additionally or alternatively, the present disclosure also provides a method of reducing contention and collisions in a P2P network by determining a contention window (CW) size to be used for communications via the direct wireless communication link. At times, multiple devices within the network may be synchronized in time, for example due to beacons which share common timing. Synchronized devices, or beacons, may result in a number of devices attempting to transmit during a similar time, such as the start of a paging window or a data window. By transmitting during a similar time, the devices may experience contention or collisions with other transmitting devices, which may result in loss of information or system congestion. As such, it is desirable to distribute transmissions throughout a timing window, such as a paging window or a data window, to reduce contention and collisions. In one example, a transmitting station may identify a metric associated with communications to other nodes via the direct wireless communication link and determine a duration of the CW. Generally, the CW duration may be optimized based on the metric, e.g., based on the number of nodes communicating via the direct wireless communication link. For example, relatively short CW durations may be optimal for networks comprising fewer nodes whereas longer CW durations may be more optimal for networks comprising larger numbers of nodes. Thus, the present disclosure further reduces contention and collisions by establishing a CW duration that is suited to the particular (e.g., metrics) communications via the direct wireless communication link.

In an illustrative set of examples, a method for wireless communication is described. The method may include: transmitting, to at least a first node of one or more nodes, a traffic announcement message, indicating data pending for at least the first node, in a first order during a paging window; and transmitting, to at least the first node, the data in a second order during a data transmission window, the second order of the data transmission window chronologically corresponding to the first order of the paging window.

The method may include determining a transmission time period for the data transmission to at least the first node in the second order of the data transmission window. The traffic announcement message may include an indication of the transmission time period. The method may include determining whether an acknowledgment of the traffic announcement message is received from at least the first node. Determining whether an acknowledgement of the traffic announcement message is received may include receiving, during the paging window, an acknowledgment message from at least the first node, the acknowledgment message acknowledging reception of the transmitted traffic announcement message and comprising an indication of the transmission time period. Determining the transmission time period may include: identifying a communication metric associated with transmissions to at least the first node; and determining an amount of data for transmission to at least the first node in the second order of the data transmission window.

In some aspects, the traffic announcement message may include a transmission window start time for the data transmission to at least the first node in the second order of the data transmission window. The method may include identifying at least one parameter associated with a data transmission from a neighboring node during a third order of the data transmission window, the third order being prior to the second order; and determining a start time for the data transmission to at least the first node in the second order of the data transmission window.

In some aspects, the method may include identifying a metric associated with communications to one or more nodes via a direct wireless communication link; and determining a duration for a contention window for at least a portion of the communications to the one or more nodes based on the metric. The contention window may be associated with communications during the paging window and the metric is based at least in part on a count value of the one or more nodes communicating via the direct wireless communication link during the paging window. The contention window may be associated with communications during the data transmission window and the metric is based at least in part on a count value of the one or more nodes communicating via the direct wireless communication link during the data transmission window. The metric may be based at least in part on at least one of a duration of a timing interval associated with communications via the direct wireless communication link, a size of the traffic announcement message, a collision probability metric, a data type for the data transmission, or a priority value associated with the data transmission. In some aspects, the direct wireless communication link comprises a neighbor awareness network (NAN) direct link (NDL).

In some aspects, the paging window may be at the beginning of a time block (TB) and may be associated with a time when the at least first node is awake and at least one of monitoring for, or transmitting, the traffic announcement message. The data transmission window may occur subsequent to the paging window. In some cases, the traffic announcement message is transmitted using an access category or the traffic announcement message comprises a traffic category, wherein at least one of the access category and the traffic category indicate a data type for the data transmission or a priority value associated with the data transmission.

In another illustrative set of examples, an apparatus for wireless communication is described. The apparatus may include: a transmission controller for transmitting, to at least a first node of one or more nodes, a traffic announcement message, indicating data pending for at least the first node, in a first order during a paging window; and the transmission controller for transmitting, to at least the first node, the data in a second order during a data transmission window, the second order of the data transmission window chronologically corresponding to the first order of the paging window.

In some aspects, the apparatus may include a transmission window manager for determining a transmission time period for the data transmission to at least the first node in the second order of the data transmission window. The traffic announcement message may include an indication of the transmission time period. The apparatus may include a transmission scheduling manager for determining whether an acknowledgment of the traffic announcement message is received from at least the first node. The transmission scheduling manager for determining whether an acknowledgement of the traffic announcement message is received is further for receiving, during the paging window, an acknowledgment message from at least the first node, the acknowledgment message acknowledging reception of the transmitted traffic announcement message and comprising an indication of the transmission time period.

In some aspects, the transmission window manager for determining the transmission time period is further: for identifying a communication metric associated with transmissions to at least the first node; and for determining an amount of data for transmission to at least the first node in the second order of the data transmission window. The traffic announcement message may include a transmission window start time for the data transmission to at least the first node in the second order of the data transmission window.

In some aspects, the apparatus may include a transmission scheduling manager for identifying at least one parameter associated with a data transmission from a neighboring node during a third order of the data transmission window, the third order may be prior to the second order, and the transmission scheduling manager for determining a start time for the data transmission to at least the first node in the second order of the data transmission window. The data transmission window may occur subsequent to the paging window. The paging window may be at the beginning of a time block and may be associated with a time when the at least first node is awake and at least one of monitoring for, or transmitting, the traffic announcement message. The traffic announcement message may be transmitted using an access category or the traffic announcement message may include a traffic category, at least one of the access category and the traffic category may indicate a data type for the data transmission or a priority value associated with the data transmission.

In some aspects, the apparatus may further include a transmission window manager for identifying a metric associated with communications to one or more nodes via a direct wireless communication link, and determining a duration for a contention window for at least a portion of the communications to the one or more nodes based on the metric. The contention window may be associated with communications during the paging window and the metric may be based at least in part on a count value of the one or more nodes communicating via the direct wireless communication link during the paging window. In some cases, the contention window may be associated with communications during the data transmission window and the metric may be based at least in part on a count value of the one or more nodes communicating via the direct wireless communication link during the data transmission window.

In some aspects, the metric may be based at least in part on at least one of a duration of a timing interval associated with communications via the direct wireless communication link, a size of the traffic announcement message, a collision probability metric, a data type for the data transmission, or a priority value associated with the data transmission. In some cases, the direct wireless communication link may include a neighbor awareness network direct link.

In another illustrative set of examples, a method for wireless communications is described. The method may include: identifying a transmission window associated with one or more nodes of a direct wireless communication link; and transmitting, to at least a first node of the one or more nodes, a first message during an initial portion of the transmission window, the first message comprising a reservation field identifying reserved resources of the direct wireless communication link for at least a remaining portion of the transmission window, the first message further comprising an identifier of the direct wireless communication link.

In some aspects, the transmission window may include a paging window and the first message comprises a traffic announcement message, indicating data pending for at least the first node, and wherein the paging window is associated with a time when the at least first node is awake and at least one of monitoring for, or transmitting, the traffic announcement message. The transmission window may include a data transmission window and the first message may include a data transmission. The first message may include a clear-to-send (CTS) message, the CTS message comprising a CTS-to-self field. The method may include receiving an acknowledgement of the first message from at least the first node, the acknowledgement may include an indication of the reservation field. The direct wireless communication link may include a neighbor awareness network (NAN) direct link (NDL) and the identifier identifies the NDL. The identifier may be used by the one or more nodes of the NDL to facilitate transmissions during the transmission window and prevents out-of-network nodes from sending transmissions during the transmission window.

In some aspects, the method may include determining that at least one of the one or more nodes of the direct wireless communication link has transmitted a second message during the transmission window. The reservation field may include a network allocation vector (NAV). The method may include: identifying a metric associated with communications to the one or more nodes via the direct wireless communication link; and determining a duration for a contention window for at least a portion of the communications to the one or more nodes based on the metric. The contention window may be associated with communications during a paging window and the metric may be based at least in part on a count value of the one or more nodes communicating via the direct wireless communication link during the paging window. The contention window may be associated with communications during the transmission window and the metric may be based at least in part on a count value of the one or more nodes communicating via the direct wireless communication link during the transmission window. The metric may be based at least in part on at least one of a duration of a timing interval associated with communications via the direct wireless communication link, a size of a traffic announcement message, a collision probability metric, a data type for the data transmission, or a priority value associated with the data transmission.

In another illustrative set of examples, an apparatus for wireless communications is described. The apparatus may include: a transmission window manager for identifying a transmission window associated with one or more nodes of a direct wireless communication link; and a transmission controller for transmitting, to at least a first node of the one or more nodes, a first message during an initial portion of the transmission window, the first message comprising a reservation field identifying reserved resources of the direct wireless communication link for at least a remaining portion of the transmission window, the first message further comprising an identifier of the direct wireless communication link.

In some aspects, the apparatus may include a transmission scheduling manager for determining that at least one of the one or more nodes of the direct wireless communication link has transmitted a second message during the transmission window. The reservation field may include a network allocation vector.

In some aspects, the apparatus may include the transmission controller for identifying a metric associated with communications to the one or more nodes via the direct wireless communication link; and the transmission window manager for determining a duration for a contention window for at least a portion of the communications to the one or more nodes based on the metric. The contention window may be associated with communications during a paging window and the metric may be based at least in part on a count value of the one or more nodes communicating via the direct wireless communication link during the paging window. The contention window may be associated with communications during the transmission window and the metric may be based at least in part on a count value of the one or more nodes communicating via the direct wireless communication link during the transmission window. The metric may be based at least in part on at least one of a duration of a timing interval associated with communications via the direct wireless communication link, a size of a traffic announcement message, a collision probability metric, a data type for the data transmission, or a priority value associated with the data transmission.

In some aspects, the transmission window may include a paging window and the first message may include a traffic announcement message, indicating data pending for at least the first node, and wherein the paging window is associated with a time when the at least first node is awake and at least one of monitoring for, or transmitting, the traffic announcement message. The transmission window may include a data transmission window and the first message may include a data transmission. The first message may include a clear-to-send (CTS) message, the CTS message comprising a CTS-to-self field. The apparatus may include a transmission scheduling manager for receiving an acknowledgement of the first message from at least the first node, the acknowledgement may include an indication of the reservation field. The direct wireless communication link may include a neighbor awareness network (NAN) direct link (NDL) and the identifier identifies the NDL. The identifier may be used by the one or more nodes of the NDL to facilitate transmissions during the transmission window and prevents out-of-network nodes from sending transmissions during the transmission window.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 illustrates a wireless local area network (WLAN) (also known as a Wi-Fi, P2P, or data link network) for reducing contention in the network in accordance with various aspects of the present disclosure

FIGS. 2A and 2B illustrate examples of a wireless communication subsystem for reducing contention in a P2P network in accordance with various aspects of the present disclosure;

FIG. 3 illustrates a timing diagram for reducing contention in a P2P network in accordance with various aspects of the present disclosure;

FIGS. 4A and 4B illustrate example timing diagrams for reducing contention in a P2P network in accordance with various aspects of the present disclosure;

FIG. 5 shows a block diagram of a device for reducing contention in a P2P network in accordance with various aspects of the present disclosure;

FIG. 6 shows a block diagram of a device for reducing contention in a P2P network in accordance with various aspects of the present disclosure;

FIG. 7 illustrates a block diagram of a system for reducing contention in a P2P network in accordance with various aspects of the present disclosure;

FIG. 8 shows a flowchart illustrating a method for reducing contention in a P2P network in accordance with various aspects of the present disclosure;

FIG. 9 shows a flowchart illustrating a method for reducing contention in a P2P network in accordance with various aspects of the present disclosure;

FIG. 10 shows a flowchart illustrating a method for reducing contention in a P2P network in accordance with various aspects of the present disclosure; and

FIG. 11 shows a flowchart illustrating a method for reducing contention in a P2P network in accordance with various aspects of the present disclosure.

### DETAILED DESCRIPTION

The described features generally relate to improved systems, methods, and/or apparatuses for reducing contention in a direct link network, such as a P2P or data link network. In accordance with the present disclosure, a data link network or P2P network may be implemented to support multi-hop communication for a Neighbor Awareness Network (NAN), also referred to as a NAN direct link or NDL. In some examples, a P2P network may be a fully connected network in which each member station has a connection with every other station on the network. Also, a P2P network may be a partially connected network in which some member stations may be connected in a full connectivity scheme, but other member stations are only connected to one or more of the stations, but not all of the member stations of the network. Further, a P2P network may extend the capabilities of a Wi-Fi framework to enable participating stations to establish direct link connectivity for content delivery. In some examples, one or more participating stations or nodes may form a direct wireless communication link for content delivery, e.g., transmitting node(s) delivering content for one or more receiving nodes. The direct wireless communication link may again be referred to as a NAN direct link or NDL.

Direct link networks may be used for static topologies and ad-hoc or NAN. In some instances, a data link or NAN data link or NDL or P2P may be referred to as a “Social Wi-Fi,” (SWF) mesh network and therefore such terms may be used interchangeably herein. The described techniques may be applied to various mesh network topologies and/or other P2P networks. A network may comprise a plurality of devices or nodes, each of which is capable of relaying data within the network on behalf of other devices in a NDL environment. The data transmitted or relayed between the devices may similarly create a data path (“DP”) wherein the “path” describes the data flow from one device to another. Accordingly, a NDL may comprise data transferred from a service provider to a service consumer, as described below.

A NAN DP may include more than one “hop.” A “hop” as used herein depends on the number of devices between the device providing the service (provider device) and the device consuming the service or “subscribing” (subscriber device) to the service in the DP. For example, a service that is relayed by one device may be referred to as two hops: provider STA (hop one) to proxy STA, (hop two) to seeker STA. While NAN may refer to a subset or network of devices capable of one-hop service discovery, a DP may be capable of service discovery and subscription over multiple hops (multi-hop).

In certain embodiments, a group or a “DP group” of nodes may connect to form a NDL. A NDL group may generally refer to a subset of a NAN cluster that shares a common transmission window, e.g., a common paging window (PW) that precedes a common data transmission window. The transmission window for the NDL group may have common security credentials for each of the devices, which may serve to restrict membership within the NDL. Accordingly, a restricted NDL may require out-of-band credentialing. Each DP group or NDL may also be associated with a unique identifier, such as an NDL ID, that distinguishes NDL groups from each other. In some instances, the transmission window(s) for a first NDL may be the same or different from a transmission window for a second NDL.

In some examples, direct link networks may be formed between a first station and one or more second station(s) to provide services to the first station. In order to establish a network for the above-referenced communication, the first station may discover or otherwise become aware of a second station in the network. In some examples, the second station may provide a desired service, e.g., access to the Internet or music streaming. As a result, the first station may request content delivery of the desired service(s) by propagating a request in the network to the second station. In response, a second station may transmit a traffic announcement message to the first station during a paging period to inform the first station that the second station has pending data for transmission.

In a congested network, multiple stations in the network may attempt to transmit each stations' respective traffic announcement messages during the same paging period. However, access to the transmission medium may be constrained to support only a limited number of simultaneous transmissions. As a result of the limited medium resources, a number of traffic announcement messages from the one or more transmitting stations may be dropped from the medium. Thus, in some examples, the receiver station(s) may be unaware of the pending transmission, and may enter a power saving mode during the data transmission period, resulting in further loss of data. Generally, lack of coordination between the transmitting stations may not provide a scheduled order for the data transmissions during the data transmission window and therefore the transmitting station(s) may subsequently attempt to transmit the corresponding data to the receiver station(s) (e.g., first station) during the data transmission period. Such uncoordinated transmissions may result in an inefficient use of limited resources (e.g., transmission medium and power consumption). Moreover, such behavior may impede the ability of another member station from unencumbered utilization of the medium during the data transmission period.

In accordance with the present disclosure, a method for reducing contention in a P2P network or NDL is described. Specifically, the present disclosure may provide a method of coordinating data transmissions during the data transmission window based at least in part on an order of capturing the shared medium of the direct wireless communication link of the NDL. For example, a transmitting node may transmit to a first receiving node (or a plurality of receiving nodes) a traffic announcement message in a first order. The first order may, in some example, be associated with the order in which the transmitting node transmitted its traffic announcement message from among other transmitting nodes sending traffic announcement messages during the paging window. The transmitting node may then transmit data to the first receiving node during the data transmission window in a second order that corresponds to the first order. For example, if the transmitting node was a second transmitting node to send its traffic announcement message during the paging window, it may send its data transmission in the second order during the data transmission window. Similarly, if the transmitting node was a first transmitting node to send its traffic announcement message during the paging window, it may send its data transmission in the first order of the data transmission window.

Additionally or alternatively, the present disclosure may also provide a method of reducing contention in a NDL by reserving one or more resources of the medium for other member nodes, i.e., nodes belonging to the same NDL. For example, a transmitting node may identify a transmission window (e.g., a paging window) associated with node(s) of the direct wireless communication link, e.g., NDL. The transmitting node may transmit a first message (e.g., a traffic announcement message) to at least the first receiving node (or a plurality of receiving nodes) that includes a reservation field identifying the reserved resources of the link for at least a remaining portion of the transmission window. In some examples, the reservation field may include a network allocation vector (NAV) that reserves the resource. The first message may also include an identifier of the direct wireless communication link, e.g., a NLD ID. Accordingly, other transmitting nodes that belong to the same network, e.g., that are associated with the same identifier, may receive the first message reserving the medium for the remaining portion of the transmission window, determine that the identifier is associated with their own network (e.g., NDL), and transmit their respective messages during the remaining portions of the transmission window.

Additionally or alternatively, the present disclosure may also provide a method of reducing contention in a P2P network by establishing a contention window (CW) for communications during the transmission window. For example, a transmitting node may identify various metrics associated with communications via the direct wireless communication link (e.g., NDL) and determine a CW duration based on the metrics. Example metrics include, but may not be limited to, the number of nodes of the NDL, a duration of a timing interval, a size of the traffic announcement (or first) message, a collision probability metric, a data type/priority, etc., for communications via the direct wireless communication link. Accordingly, the CW may be determined that minimizes the time spent by nodes attempting to capture the shared wireless medium and yet ensures that medium access is available for transmissions during the transmission windows.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

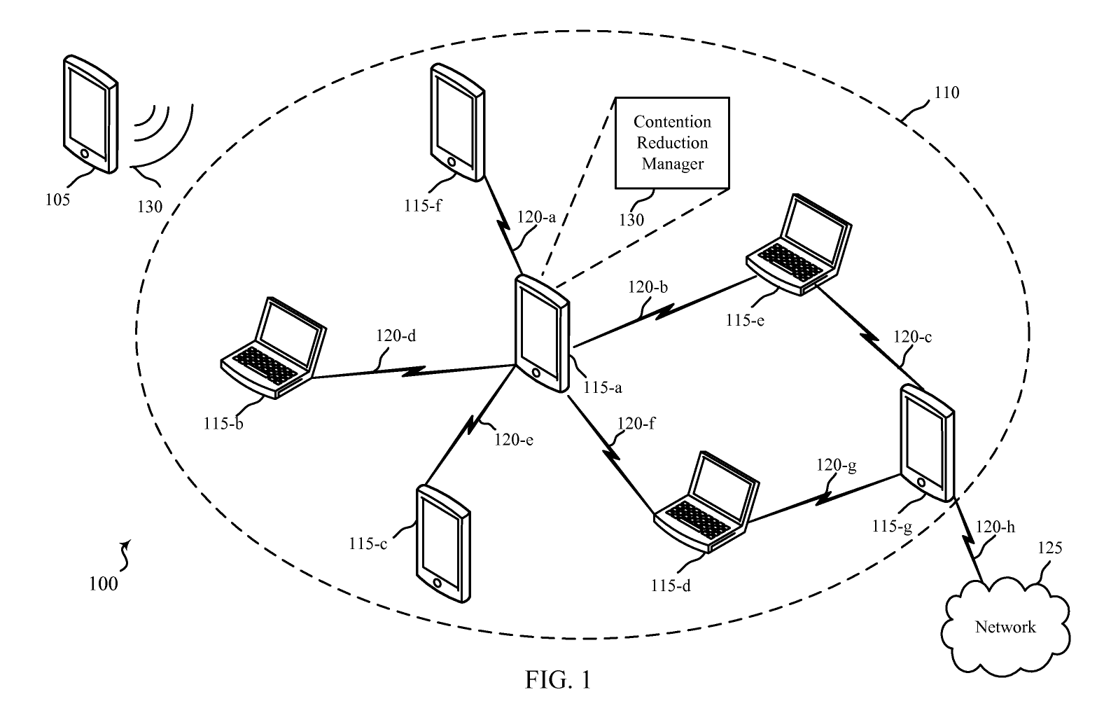

FIG. 1 illustrates a WLAN 100 (also referred to as a Wi-Fi network, a data link network, a P2P network, or NDL) configured in accordance with various aspects of the present disclosure. The WLAN network 100 includes an established NDL network 110. The NDL network 110 may be implemented as a wired or wireless communication network of various fixed and/or mobile devices, that may be referred to as “nodes” or “stations” 115. Each of the node devices 115 may receive and communicate data throughout the NDL network 110, such as throughout a college campus, metropolitan area, community network, and across other geographic areas. A node device 115 may also function to route data from one node to another within the NDL network 110. In addition, each node 115 may typically have more than one communication link to and/or from other nodes 115 of the NDL network 110, which provides for redundant communication links and a reliable communication system. For instance, node 115-a may establish communication with node 115-g via either intermediate nodes 115-d or 115-e respectively. In some examples, one or more nodes 115 may include contention reduction manager 130 to perform the functionalities of the present disclosure to reduce contention for resources among multiple nodes 115.

As shown in FIG. 1, the NDL network 110 is a partially connected network, with connections or communication links 120 established between the nodes 115-a through 115-g such that each of the nodes may communicate with all of the other nodes of the NDL network 110, some directly and some indirectly. The NDL network 110 may be connected to an external network 125, such as the Internet, by one or more of the member devices (e.g., node 115-g in this example) establishing a connection or communication link 120 with the external network 125. Although not shown, the node 115-g may establish its connection with a base station or access point that has access to the external network 125.

The wireless NDL network 110 may include various node devices 115 implemented for wireless communication utilizing a data packet routing protocol, such as Hybrid Wireless Mesh Protocol (HWMP) for path selection. In some examples, the NDL network 110 may also be implemented for data communication with other networks that are communicatively linked to the network, such as with another wireless network, wired network, wide-area-network (WAN), and the like.

In the wireless NDL network 110, communication links 120 may be formed between the various nodes 115 of the network. The data packets for wireless communication in the network may be forwarded or routed from a source node (e.g., transmitting device) to an originator node (e.g., receiving device) via intermediate node(s), which are commonly referred to as “hops” in a multi-hop wireless NDL network. For instance, communication from a first node 115-a to second node 115-f via communication link 120-a may be considered “one-hop.” Similarly, communication between a first node 115-a to a third node 115-g via intermediate node 115-e and communication links 120-b and 120-c may be considered “two-hops” for the purpose of this disclosure. Communication between multiple devices, however, is not limited to either one or two hops, and may comprise any number of hops required for establishing communication between a plurality of mobile devices via the selected path.

In one example, wireless communication device 105 may be in proximity of the NDL network 110. The wireless communication device 105 may join the NDL network 110 by authenticating with only one of the member nodes 115 of the existing NDL network 110. Upon successfully completing an authentication procedure, the wireless communication device 105 may receive a group key common to the devices of the NDL network 110 and use the common group key to discover the topology of the existing NDL network 110 by sending a route request message to the other devices and receiving route reply messages from one or more of the other devices. Based on the received route reply messages, the wireless communication device 105 may determine a topology of the NDL network 110 and, accordingly, determine a route or path to a provider device of the NDL network 110 providing a desired service.

In one configuration, multiple stations (e.g., nodes 115-f and 115-e) may request content delivery (e.g., music streaming) from source nodes (e.g., 115-b and 115-c) of the NDL network 110. In some examples, the source nodes 115-b and 115-c may advertise NDL parameters (also referred to as Data Path attributes) as part of the service advertisements. The parameters may include attributes regarding the NDL network 110, including identifying when the transmission window starts, start time offset between consecutive transmission windows, the size of the transmission window, the size of the paging window, and the time slots associated with each of the paging window and the transmission window. In some examples, nodes 115 desiring to participate in the content delivery may form a NDL for the purposes of the content delivery, wherein the nodes 115 of the NDL network 110 may share a common transmission window timing.

Based on the advertised parameters, each of the source nodes (i.e., 115-b and 115-c) may transmit a traffic announcement message to receiver nodes 115-f and 115-e during a paging period (also referred as “paging window”). The traffic announcement may identify at least one receiver node (i.e., 115-f and/or 115-e) and indicate that the source node(s) (i.e., 115-b and/or 115-c) have pending data for at least one receiver node(s) 115-f and/or 115-e. In transmitting the traffic announcement messages, the source nodes (i.e., 115-b and 115-c) may generally contend for the shared medium using a clear channel assessment (CCA) procedure, for example, or some other listen-before-talk (LBT) procedure. Source node 115-b may capture the medium first and send its traffic announcement message followed by source node 115-c capturing the medium second and sending its traffic announcement message. Therefore, in order of traffic announcement message transmission, source node 115-b may be considered first and source node 115-c may be considered second. Source nodes 115-b and 115-c may subsequently transmit their respective data transmissions during the data transmission window based on their traffic announcement message transmission order. In some cases, the order may be a chronological order, or an order with respect to time. For example, source node 115-b may send its data transmission first followed by source node 115-c sending its data transmission second, i.e., corresponding to the transmission order during the paging window.

In some configurations, at least one source node 115 (i.e., nodes 115-b or 115-c) may provide for contention reduction by reserving the shared wireless medium for the other source node(s) 115 by reserving the medium during the transmission window. For example, source node 115-b, for example, may identify the transmission window (i.e., the paging window and/or the data transmission window) for the nodes communicating via the NDL network 110. Source node 115-b may transmit a first message during an initial portion of the transmission window (e.g., during the first portion of the paging window) that includes a reservation field. The reservation field may indicate that the shared wireless medium of the NDL network 110 is reserved for the remaining portion of the transmission window. The first message may also include an identifier for the NDL network 110. Other source nodes 115 (e.g., source node 115-c) may receive the first message reserving the resource, determine that the identifier is associated with the NDL network 110 (i.e., the same NDL network) and therefore transmit their respective messages during the remaining portion of the transmission window. Other nodes, e.g., nodes that are not a part of the NDL network 110 may receive the first message and, based on the identifier and the reservation field, determine that the medium is busy during the remaining portion of the transmission window and therefore refrain from transmissions.

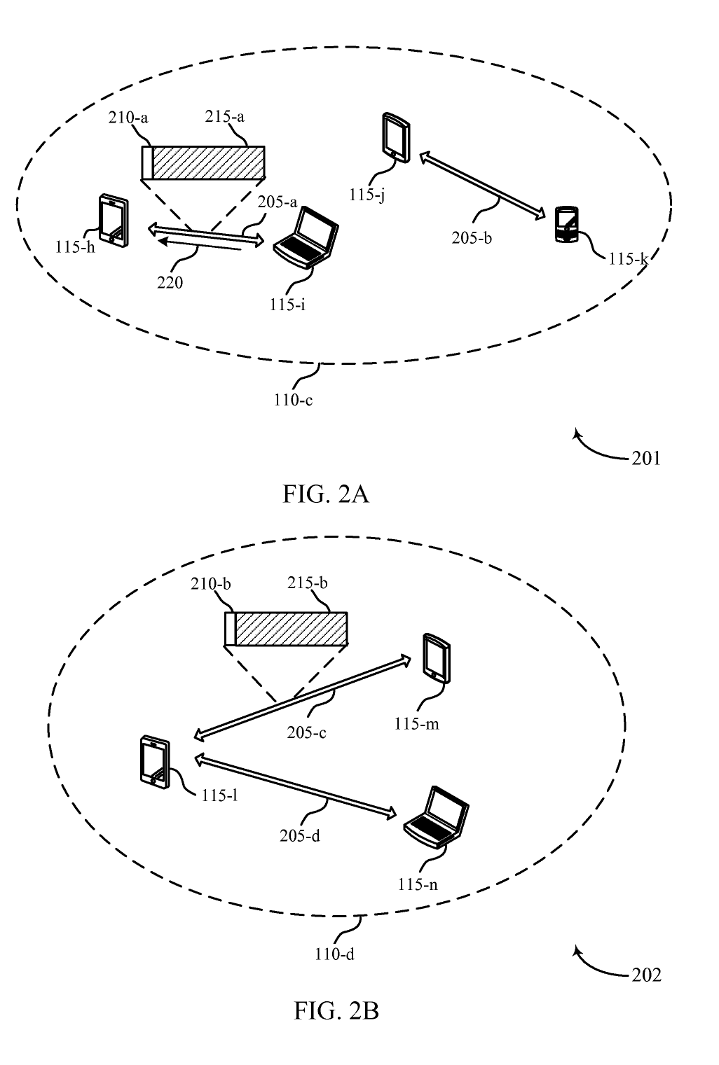

FIG. 2A and FIG. 2B illustrate an example of a wireless communication subsystems 201 and 202 for reducing contention in a P2P network or NDL in accordance with various aspects of the present disclosure. Wireless communication subsystem 201 may include nodes (or stations) 115-h, 115-i, 115-j, and 115-k, which may be an example of a STA or node 115 described above with reference to FIG. 1. Similarly, wireless communication subsystem 202 may include stations 115-l, 115-m and 115-n, which may be an example of a STA or node 115 described with reference to FIGS. 1 and 2A. The subsystems 201 and 202 may further include an established NDL network 110-c and 110-d, which may be an example of a NDL network 110 with reference to FIG. 1.

Referring now to FIG. 2A, the present disclosure provides a method for multiple source node(s) 115-h and 115-j to deliver content to multiple receiver nodes 115-i and 115-k. In one example, each of the source nodes(s) 115-h and 115-j may transmit communication signals 205 between multiple nodes 115. In some cases, the communication signals 205 may be a part of, or referred to as, a direct wireless communication link. In some examples, the communication signals 205 may include a paging period 210-a and a data transmission period 215-a, which may be referred to as transmission windows. In one example, nodes 115-h may transmit a traffic announcement message to receiver node 115-i during a paging period 210-a during the communication signal 205-a. Optionally, the receiver node 115-i may transmit an acknowledgment message 220 during a paging period 210-a or a data transmission period 215-a. Additionally or alternatively, the receiver node 115-i may transmit a trigger message during the data transmission period 215-a.

At times, a number of acknowledgment messages 220 may be transmitted, such as from the same receiver node 115-i. For example, a source node 115-h may transmit the traffic announcement message, or a page, to a number of receiver nodes 115-i and 115-k, such as during the paging period 210-a. A number of receiver node(s), such as one receiver node 115-i, may transmit an acknowledgment message 220 to the source node 115-h during the paging period 210-a to acknowledge that the traffic announcement message, or page, was successfully transmitted or received (e.g., without collision). The acknowledgment message 220 may be transmitted a short interframe space (SIFS) interval after receiving the traffic announcement message, or page.

During the data transmission period 215-a, a number of receiver node(s), such as all receiver nodes which successfully received the traffic announcement message, or page, may transmit a trigger message, or trigger frame, which may indicate to the source node 115-h that the receiver node(s) is awake, or in an active state, or prepared to receive data (e.g., during the data transmission period 215-a). At times, the acknowledgment message 220 may include a trigger frame or a trigger message. The trigger message may be a Power-Save Poll (PS-POLL) frame, a broadcast PS-POLL frame, or a QoS null frame with, or without, a reverse direction grant (RDG) flag. The trigger message may be a multicast message which addresses multiple transmitters, or source nodes 115-h and 115-j, in one message. Further, the trigger message may include information which may identify or indicate the network, such as the NDL. Identifying the network may help filter received messages.

The RDG flag may enable the source node 115-h to send data without contending for the medium. For example, the source node 115-h may transmit data after a SIFS interval, such as upon receiving the QoS null frame with the RDG flag. At times, a QoS null frame, such as with an RDG flag, may be a unicast frame, and may be transmitted to a single source node 115-h. In contrast, a QoS null frame, such as with an RDG flag, may be multicast and may indicate an order of transmitters, or source nodes 115-h and 115-j. A QoS null frame, such as without an RDG flag, may be used as a trigger frame and may be multicast to multiple source nodes 115-h and 115-j, or may be unicast and transmitted to a number of source nodes 115-h and 115-j.

In some examples, the receiver node 115-i may transmit an acknowledgment message 220 or a trigger message to the source node 115-h during both, or one of, the paging period 210-a and the data transmission period 215-a. The acknowledgment message 220 or trigger message transmitted during the paging period 210-a may be similar to, or the same as, the acknowledgment message 220 or trigger message transmitted during the data transmission period 215-a. The acknowledgment message 220 or trigger message transmitted during the paging period 210-a may be different from the acknowledgment message 220 or trigger message transmitted during the data transmission period 215-a. In some examples, the communication signal 205 may be an example of a communication link 120 with reference to FIG. 1.

In some aspects, the traffic announcement message may indicate traffic to multiple recipients, i.e., receiver nodes 115 and may therefore include an indication of all intended recipient nodes. In some instances, only one recipient node 115 may need to send the acknowledgement message 220 to confirm acknowledgement of the traffic announcement. For example, the order of intended recipients may be used to identify which recipient node 115 is expected to send the acknowledgement message 220. There may be other criteria which determines which recipient node 115 sends the acknowledgement 220, e.g., node 115 location, node 115 measured signal strength, etc.

In one example, both source nodes 115-h and 115-j may attempt to capture the shared wireless medium during the paging period 210-a to transmit the traffic announcement messages. For example, each source node 115-h and 115-j may initiate a CCA procedure to sense energy on the medium to determine if the medium is available or busy. Source node 115-h, for example, may complete its CCA procedure first, capture the medium, and transmit its traffic announcement message in a first order. In some cases, the order may be a chronological order, or an order with respect to time. Once source node 115-h completes its transmission, the medium may again be sensed free and source node 115-j may then complete its CCA procedure, capture the medium, and transmit its traffic announcement message. Based on the order of traffic announcement message transmission, each of the source nodes 115-h and 115-j may be allocated an order for the data transmission period. For example, source node 115-h may transmit its data transmission in a second order during the data transmission, the second order corresponding to the order for the traffic announcement message transmission. The correspondence of the order for the traffic announcement (e.g., the first order) and the order for the data transmission (e.g., the second order) may be chronologically based, or may be a correspondence with respect to time. For example, if during the first order a source node 115-h transmits before the source node 115-j during the paging window, the second order may chronologically correspond to the first window in that the source node 115-h may transmit before the source node 115-j during the data transmission window. Source node 115-j may transmit its data transmission in a different order, based on its order for traffic announcement message transmission. Thus, source nodes 115-h and 115-j may know which order they will be scheduled to send data transmissions during the data transmission periods 215-a based on the order in which they transmitted their respective traffic announcement messages during the paging period 210-a. As such, source nodes 115-h and 115-j may contend during their respective transmission order during data transmission period 215-a to transmit data to the receiver nodes 115-i and 115-k.

Additionally or alternatively, source nodes 115-h and 115-j may estimate the time required to transmit its buffered data to the receiver nodes 115-i and 115-k and include an indication of such time in its traffic announcement message. For example, the source nodes 115-h and 115-j may make reasonable assumptions regarding the transmit time based on the amount of buffered data, the data rates supported by the receiver nodes 115-i and 115-k, estimated or measured packet error rates (PER) and/or retransmissions to the receiver nodes 115-i and 115-k, etc. Source nodes 115-h and 115-j may determine the transmit time based on such information to determine how long it estimates to will take to send its data transmissions during the corresponding data transmission period 215-a. The source nodes 115-h and 115-j may, in some examples, include an indication of the transmit time in its traffic announcement message (e.g., paging message) to the receiver devices 115-i and 115-j. Receiver nodes 115-i and 115-j may include an indication of the transmit time in an acknowledgement message 220 or trigger message to the respective source nodes 115-h and 115-j. Accordingly, the receiving nodes 115-i and 115-j may provide confirmation to the transmitting nodes 115-h and 115-j of successful receipt of the traffic announcement messages and, in some circumstances, provide an indication to other nodes informing them that the data transmissions will occur during the data transmission period 215-a, and for how long. Although the above discussion refers to the transmit time, other implementations may include the source nodes 115-h and 115-j determining an amount of data to be transmitted and including an indication of this information in the traffic announcement messages. Other information may also be included which may be used by receiving nodes 115-i and 115-j (or other nodes) to determine the estimated transmission time.

Additionally or alternatively, source nodes 115-h and 115-j may estimate a start time for the data transmissions in the data transmission period 215-a. For example and continuing with the example above, source node 115-h may be the first source node to send its traffic announcement message during the paging period 210-a and therefore be scheduled first to send its data transmission during the data transmission period 215-a. Since source node 115-h is scheduled to send its data transmission first, it may determine that its start time is at time Tₙ, where n may be zero (0). Source node 115-h may determine that its data transmission time may be 50 us, for example. Source node 115-j may, based on it being second for data transmission, determine that its start time is Tₙ+50 us+t_{B}, for example, where B may be a buffer time added prior to starting its data transmission for various reasons (e.g., to ensure successful data transmission for node 115-h). The buffer time t_{B} may be optional, in some cases. As can be appreciated, source nodes 115 may receive traffic messages from other source nodes 115 and update their respective start time based on their order for data transmission and the estimated transmit time for preceding source node data transmissions.

In another example, at least one source node, e.g., source node 115-h, may reduce contention by reserving portions of the wireless medium resource for other source nodes 115. For example, source node 115-h may identify a transmission window, e.g., paging period 210-a and/or data transmission period 215-a, associated with communications to receiver nodes 115-i and 115-j. Source node 115-h may transmit a first message during a first portion of the transmission window that includes a reservation field reserving resources of the medium for a remaining portion of the transmission window and also an identifier for the NDL network, e.g., subsystem 201. The reservation field may include an indication of the time period the resources are reserved. In some examples, the reservation field may be a NAV field that reserves the shared wireless medium for the remaining portions of the transmission window. In one example, the reservation field may act to reserve the medium for transmissions by source nodes 115 belonging to the same NDL network and prevent transmissions from nodes from other networks for the remaining portions of the transmission period. For example and for nodes belonging to the same NDL network (e.g., source node 115-j), source node 115-j may receive the first message, determine that the identifier is for the common NDL network, and therefore determine that the resource is reserved for member-nodes, e.g., source node 115-j. Therefore, source node 115-j may transmit during the remaining portion of the transmission window via the reserved resources. Nodes belonging to other networks may receive the first message and determine that the resource is reserved for the remaining portion of the transmission window and therefore refrain from transmitting.

In some examples, the first message may be a clear-to-send (CTS) message transmitted by the source node 115-h. The source node 115-h may send the CTS message with an address field listing its own address, i.e., send the CTS message addressed to itself. This may be referred to as a CTS-to-self message and act to reserve the resource for the other source nodes 115 belonging to the same NDL network. The source node 115-h may set a NAV value in the frame header to the desired value to reserve the resource for the remaining portion of the transmission window. In other examples, the source node 115-h may send a page message as the first message, wherein the page message is addressed to other nodes 115 and includes the NAV in the frame header set to the desired value.

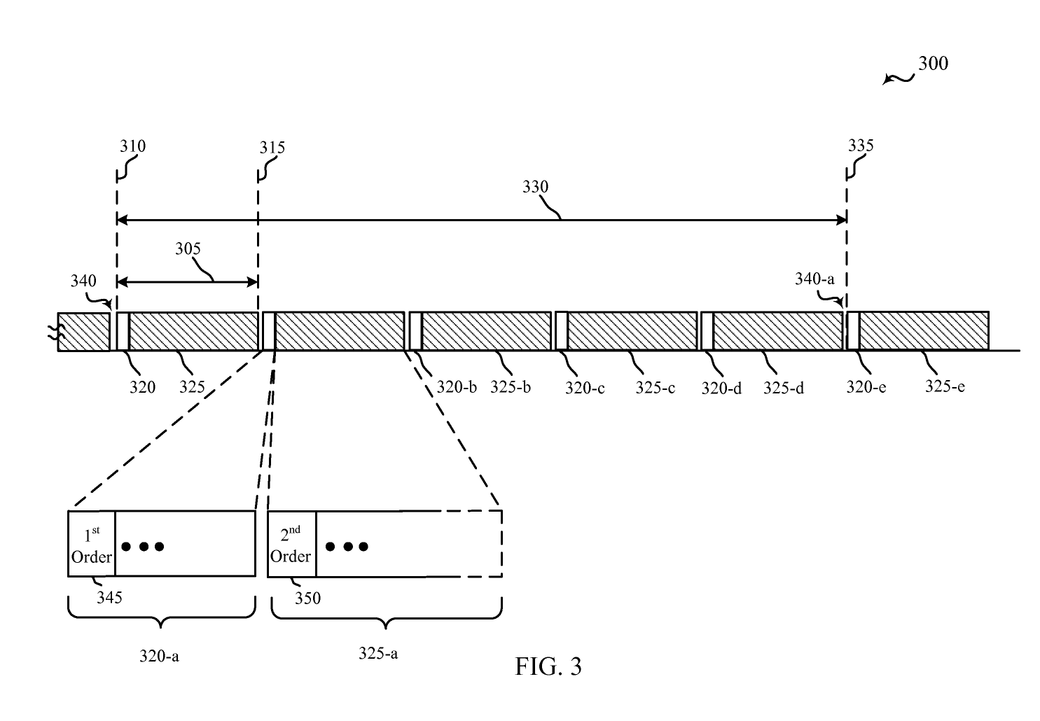

With reference to FIG. 2B, similar methods may apply to a single source/transmitter node 115-l providing content delivery to multiple receiver stations 115-m and 115-n. Similar to the above disclosed features, the source node 115-l may transmit a traffic announcement message to each receiver node 115-m and 115-n using communication signals 205-c and 205-d. In some examples, the communication signals 205-c and 205-d may include a paging period 210-b and a data transmission period 215-b. In one example, a traffic announcement message may be signaled to receiver nodes 115-m and 115-n during a paging period 210-b. Optionally, the receiver node 115-i may transmit an acknowledgment message or trigger message during a paging period 210-b or a data transmission period 215-b. The trigger message may be a PS-POLL frame, a broadcast PS-POLL frame, or a QoS null frame with, or without, an RDG flag. In response, source node 115-l may transmit its data transmission during the data transmission period 215-b in an order that corresponds to the order in which it transmitted its traffic announcement message during the paging period 210-b. In some examples, the communication signal 205 may be an example of a communication link 120 with reference to FIG. 1. Aspects of the transmission window, including the paging period 210 and data transmission period 215 will be described further with reference to FIG. 3.

In some examples, the source node 115-l may reduce contention in a NDL network by identifying or selecting a contention window. For example, source node may identify various metrics associated with the NDL network, e.g., the subsystem 202, and may determine a CW duration based on the metrics. The CW duration scheme may also be employed during various NAN discovery procedures, as discussed above.

In some examples, the metrics may be based on the timing interval associated with the NDL network, e.g., the timing interval between discovery windows. As will be discussed in more detail with reference to FIG. 3, the timing interval may include more than one paging periods 210 and data transmission periods 215 and a discovery period at the start of each timing interval. Networks (or NDLs) may have differing timing intervals dependent upon the nature or purpose of the network. For networks with a relatively short timing interval, the CW duration may be short as compared to a CW duration for networks with a longer timing interval. Moreover, a CW duration for data transmissions may generally be selected to be longer with respect to CW durations for the traffic announcement transmissions.

In one non-limiting example of metrics for CW duration calculation for a paging period 210-b, source node 115-l may identify a paging or traffic announcement message size (e.g., octet count) that may include the size associated with any expected acknowledgement messaging. The source node 115-l may also identify the communication rate for the paging message and respective acknowledgement transmissions. The source node 115-l may identify an expected or estimated collision probability metric for the transmissions and, based on the collision probability, determine an estimated CW duration per node of the NDL network. Based on this cumulative time, the source node 115-l may identify a paging window size based on the number of paging devices (e.g., nodes expected to send paging or traffic announcement messages and associated acknowledgements). The CW duration for the transmission window may then be determined as a function of the number of nodes and a function of the paging window size. It can be appreciated that the timing interval may be chosen to accommodate the appropriate number of nodes for the NDL network.

In one non-limiting example of metrics for CW duration calculation for a data transmission period 215-b, source node 115-l may identify a data transmission time for a protocol data unit (PDU) and identify the communication rate for the data transmissions. The source node 115-l may identify an expected or estimated collision probability metric for the data transmissions and, based on the collision probability, determine an estimated CW duration per node of the NDL network. Based on this cumulative time, the source node 115-l may identify a data transmission time period based on the number of paging devices (e.g., nodes expected to send data transmissions). The CW duration for the data transmission window may then be determined as a function of the number of nodes and a function of the data transmission time period. Further aspects of the transmission window, including the paging period 210 and data transmission period 215 will be described further with reference to FIG. 3.

FIG. 3 shows a timing diagram 300 illustrating various timing aspects of the present disclosure, according to various embodiments. The timing diagram 300 may be implemented by one or more aspects of the devices or nodes 115, described with reference to FIGS. 1, 2A, and/or 2B.

According to certain example, the NDL network may be a synchronized network, i.e., all of the participating device 115 may share a common timing reference to enable synchronized communications. Generally, the shared reference timing may include a data transmission session window 305 and a discovery window 340. The data transmission session window 305 may be defined as between times 310 and 315 and may include a paging period 320 at the beginning of the data transmission session window 305 as well as a data transmission period 325. At times, the data transmission session window 305 may be referred to as a time block (TB) or NDL-TB. Generally, the participating devices 115 may wake up during the paging period 320 to listen to the paging channel to determine whether there is any traffic being sent to the device 115. If there is traffic being sent, the device 115 may remain awake, or in an active state, during the data transmission period 325 to exchange the traffic (i.e., control or data information). If there is no traffic being sent, the device 115 may transition back to a sleep state during the data transmission period 325 to conserve power.

The discovery window 340 may occur during the time period between transmission windows 305. In some embodiments, the discovery window 340 may not occur before every transmission window 305 but may, instead, occur once per timing interval 330, e.g., between a predetermined number of paging periods 320. In the example shown in FIG. 3, the timing interval 330 may be defined as the time period between times 310 and 335.

Accordingly, the device 115, once joined to the NDL network, may know when the transmission window 305 occurs, and the associated paging period 320. As discussed previously, such NDL parameters may be advertised as part of the service advertisement by the provider and/or source nodes. In accordance with the present disclosure, the paging period 320 and the data transmission period 325 may be divided into an ordered sequence associated with transmissions. The number of sequenced order may comprise a one-to-one correspondence between the paging period 320 and the data transmission period 325. For instance, a source node 115 that captures the medium and transmits its traffic announcement message in a first order 345 of the paging period 320 may be given a corresponding (e.g., chronologically similar) second order 350 for data transmissions in the data transmission period 325, the second order 350 corresponding to the first order 345, e.g., first to transmit in the paging period 320 means first to transmit during the data transmission period 325.

In some examples, the allocation of the transmission order in the data transmission period 325 may be based on the corresponding order of transmissions in the paging period 320 in which each source node successfully transmitted the traffic announcement message. For example, if the a first source node successfully transmits a traffic announcement message during the first order 345 of the paging period 320-a, the first source node may transmit its data to the receiver node during the second order 350 of the data transmission period 325-a that corresponds to the first order 345 of the paging period 320-a. Conversely, if a source node successfully transmits its traffic announcement message during the second order 350 of the paging period 320, the source node may transmit data during the same order of the data transmission period 325-a.

In one example, each transmitting node may optimize its transmission by monitoring its traffic announcement transmission order during a paging period 320. For instance, in one example, a transmitting node may monitor two traffic announcement message transmissions from other source nodes and therefore determine that it is third in order for data transmissions during the data transmission periods 325.

In some examples, the traffic announcement message transmitted by the source node in the first order 345 of the paging period 320 may comprise a traffic indicator. The traffic indicator may identify an estimated amount of time that may be required to transmit the data to the receiver station during the data transmission period 325. Thus, in accordance with the present disclosure, the start time for data transmissions in the respective transmission order may be dynamically adjusted to accommodate the variable medium requirements for each source station.

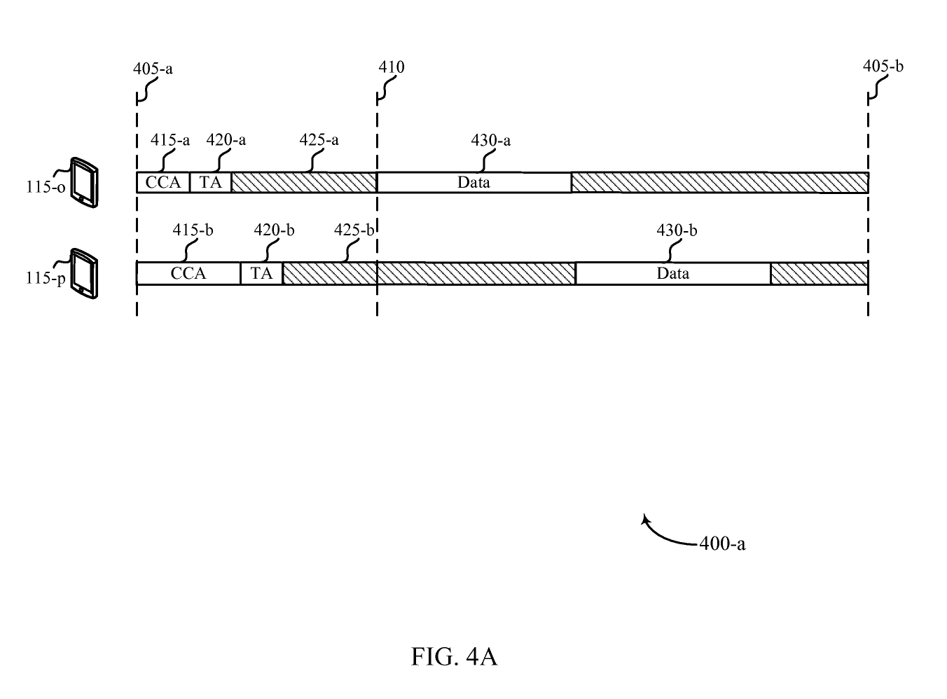

FIG. 4A and FIG. 4B illustrate example timing aspects of the present disclosure, according to various embodiments. The timing diagram 400 may be implemented by one or more aspects of the devices or nodes 115, described with reference to FIGS. 1 and/or 2.

Referring now to FIG. 4A, the shared reference timing for a NDL network may include a data transmission session window defined as between times 405-a and 405-b and may include a paging period at the beginning of the data transmission session window (between times 405-a and 410) as well as a data transmission period (between times 410 and 405-b) that follows the corresponding paging period. Generally, the participating devices 115 may wake up during the paging period to listen to the paging channel to determine whether there is any traffic being sent to the device 115. If there is traffic being sent, the device 115 may remain awake, or in an active state, during the data transmission period to exchange the traffic (i.e., control or data information). If there is no traffic being sent, the device 115 may transition back to a sleep state during the data transmission period to conserve power.

Generally, each of source nodes 115-o and 115-p may have a traffic announcement message to transmit during the paging period. Accordingly, each source node 115-o and 115-p may initiate a CCA procedure 415 during the paging period. The CCA procedure 415 for source node 115-o may complete first, for example, and capture the shared wireless medium of the NDL network. Accordingly, the source node 115-o may transmit a message, such as its traffic announcement message 420-a, once the CCA procedure 415-a is complete. Source node 115-o may transition to a sleep state for the remaining portion of the paging period. Meanwhile, source node 115-p may continue its CCA procedure 415-b and determine that the shared medium is available once source node 115-o finishes transmitting its traffic announcement message 420-a. Therefore, source node 115-p may transmit its traffic announcement message 420-b before transitioning to a sleep state 425-b. According to the example above, source node 115-o may have a first order and source node 115-p may have a second order. Therefore, source node 115-o may have a corresponding first order and send a message, such as its data transmission 430-a, during the data transmission period. Similarly, source node 115-p may have a corresponding second order and send its data transmission 430-b during the data transmission. Thus, according to certain aspects of the present disclosure, the traffic announcement message transmission order in the paging period may be used to determine the order for data transmissions in the data transmission period.

Referring now to FIG. 4B, source node 115-o may reserve the shared wireless medium for transmissions from source node 115-p during a remaining portion of the transmission period. For example, source node 115-o may identify the transmission window (e.g., the paging period) associated with communications via the NDL network. The source node 115-o may transmit a message (e.g., the traffic announcement message 420-a) during an initial portion of the transmission window that includes a reservation field 435 and an identifier of the NDL network. The reservation field 435 may reserve the shared wireless medium 440 for the remaining portion of the transmission window, e.g., from the time the traffic announcement message 420-a is sent up and until the time 410. The NDL network identifier may be a unique identifier for the associated NDL network. Source node 115-p may monitor for and receive the traffic announcement message 420-a and, based on the reservation field 435 and the identifier, determine that the shared wireless medium is reserved 440 for source nodes belonging to the same NDL network. Accordingly, source node 115-p may send its traffic announcement message 420-b during the remaining portion of the paging period.

It is to be understood that in some examples, the transmission window may refer to the data transmission period and the source node 115-o may reserve a remaining portion of the data transmission period by including a reservation field in its data transmission.

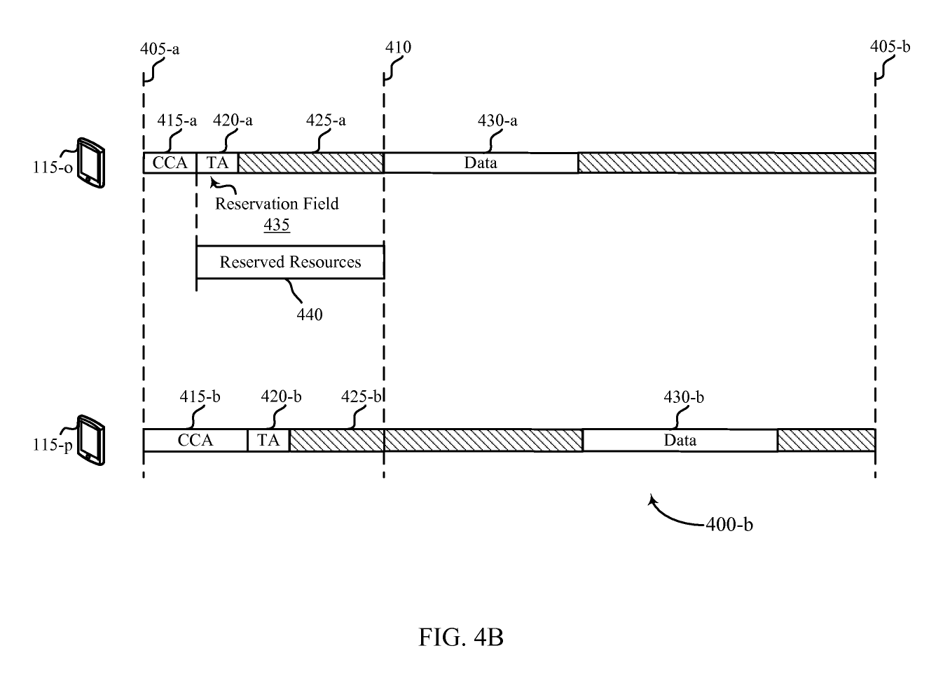

FIG. 5 shows a block diagram 500 of a STA 115-q for reducing contention in a P2P network or NDL in accordance with various aspects of the present disclosure. The STA 115-q may be an example of aspects of a STA or node 115 described with reference to FIGS. 1-4. The STA 115-q may include a receiver 505, a contention reduction manager 510, and/or a transmitter 515. The STA 115-q may also include a processor. Each of these components may be in communication with each other.

The components of the STA 115-q may, individually or collectively, be implemented with at least one application specific integrated circuit (ASIC) adapted to perform some or all of the applicable functions in hardware. Alternatively, the functions may be performed by one or more other processing units (or cores), on at least one IC. In other embodiments, other types of integrated circuits may be used (e.g., Structured/Platform ASICs, a field programmable gate array (FPGA), or another Semi-Custom IC), which may be programmed in any manner known in the art. In one embodiment, components, for example as shown in FIG. 5, each include a circuit or circuitry for reducing contention in a P2P network or NDL in accordance with various aspects of the present disclosure. The functions of each unit may also be implemented, in whole or in part, with instructions embodied in a memory, formatted to be executed by one or more general or application-specific processors.

The receiver 505 may receive information such as packets, user data, and/or control information on communication link 502 associated with various information channels (e.g., control channels, data channels, and information related to reducing contention in a P2P network, etc.). Information may be passed on to the contention reduction manager 510 via communication link 504, and to other components of the STA 115-q.

The contention reduction manager 510 may, alone or in cooperation with other components, manage one or more aspects of contention reduction for the STA 115-q. In some examples, the contention reduction manager 510 may transmit, to at least a first node of one or more nodes, a traffic announcement message in a first order during a paging window. The contention reduction manager 510 may transmit, to at least the first node, data in a second order during a data transmission window, the second order of the data transmission window corresponding to the first order of the paging window.

In some examples, the contention reduction manager 510 may additionally or alternatively, identify a transmission window associated with one or more nodes of a direct wireless communication link. The contention reduction manager 510 may transmit, to at least a first node of the one or more nodes, a first message during an initial portion of the transmission window. The first message may include a reservation field identifying reserved resources of the direct wireless communication link for at least a remaining portion of the transmission window. The first message may also include an identifier of the direct wireless communication link.

In some examples, the contention reduction manager 510 may additionally or alternatively, identify a metric associated with communications to one or more nodes via a direct wireless communication link and determine a duration of a contention window for at least a portion of the communications to the one or more nodes. The duration of the contention window may be determined based at least in part on the metric.

The transmitter 515 may transmit signals 508 received from other components of the STA 115-q, including contention reduction manager 510 on link 506. In some embodiments, the transmitter 515 may be collocated with the receiver 505 in a transceiver component. The transmitter 515 may include a single antenna, or it may include a plurality of antennas.

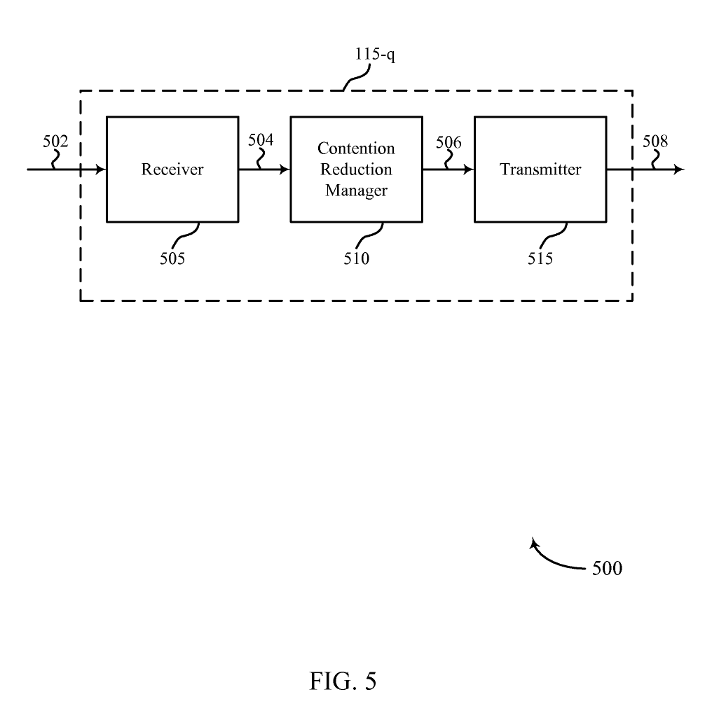

FIG. 6 shows a block diagram 600 of a STA 115-r for reducing contention in a P2P network or NDL in accordance with various aspects of the present disclosure. The STA 115-r may be an example of aspects of a STA or node 115 described with reference to FIGS. 1-4. The STA 115-r may include a receiver 505-a, a contention reduction manager 510-a, and/or a transmitter 515-a. The STA 115-r may also include a processor. Each of these components may be in communication with each other. The contention reduction manager 510-a may also include a transmission window manager 605, a transmission scheduling manager 610, and a transmission controller 615.

The components of the STA 115-r may, individually or collectively, be implemented with at least one ASIC adapted to perform some or all of the applicable functions in hardware. Alternatively, the functions may be performed by one or more other processing units (or cores), on at least one IC. In other embodiments, other types of integrated circuits may be used (e.g., Structured/Platform ASICs, an FPGA, or another Semi-Custom IC), which may be programmed in any manner known in the art. In one embodiment, components, for example as shown in FIG. 6, each include a circuit or circuitry for reducing contention in a P2P network or NDL in accordance with various aspects of the present disclosure. The functions of each unit may also be implemented, in whole or in part, with instructions embodied in a memory, formatted to be executed by one or more general or application-specific processors.

The receiver 505-a and the transmitter 515-a be configured to perform the functions of the receiver 505 and the transmitter 515 described with reference to FIG. 5. For example, the receiver 505-a may receive information via link 602 which may further be passed on to the contention reduction manager 510-a via link 604, and to other components of the STA 115-r. The contention reduction manager 510-a may perform the operations described above with reference to FIG. 5. The transmitter 515-a may transmit signals 608 received from other components of the STA 115-r.

The transmission window manager 605 may monitor, control, or otherwise manage one or more aspects of transmission windows for the STA 115-r as described above with reference to FIGS. 1-4. In some examples, the transmission window manager 605 may identify a transmission window associated with one or more nodes of a direct wireless communication link. The transmission window manager 605 may determine a transmission time period for a data transmission to at least a first node in the second order of the data transmission window. Determining the transmission time period may include identifying a communication metric associated with transmissions to at least the first node and determining an amount of data for transmission to at least the first node in the second order of the data transmission window.

In some aspects, the transmission window manager 605 may identify a metric associated with communications to one or more nodes via a direct wireless communication link, and determine a duration for a contention window for at least a portion of the communications to the one or more nodes based on the metric. The contention window may be associated with communications during the paging window and the metric may be based at least in part on a count value of the one or more nodes communicating via the direct wireless communication link. The contention window may be associated with communications during the data transmission window and the metric may be based at least in part on a count value of the one or more nodes communicating via the direct wireless communication link. The metric may be based at least in part on at least one of a duration of a timing interval associated with communications via the direct wireless communication link, a size of the traffic announcement message, a collision probability metric, a data type for the data transmission, a priority value associated with the data transmission, or combinations thereof.

The transmission scheduling manager 610 may monitor, control, or otherwise manage one or more aspects of scheduling transmissions for the STA 115-r, as described above with reference to FIGS. 1-4. In some examples, the transmission scheduling manager 610 may transmit, to at least a first node of the one or more nodes, a first message during an initial portion of the transmission window, the first message comprising a reservation field identifying reserved resources of the direct wireless communication link for at least a remaining portion of the transmission window, the first message further comprising an identifier of the direct wireless communication link.

In some aspects, the transmission window may include a paging window and the first message may include a traffic announcement message. The transmission window may be a data transmission window and the first message may include a data transmission. The first message may be a clear-to-send (CTS) message, the CTS message may include a CTS-to-self field.

In some aspects, the transmission scheduling manager 610 may determine whether an acknowledgment of the traffic announcement message, or a trigger message, is received from at least the first node. Determining whether an acknowledgement of the traffic announcement message is received may include receiving, during the paging window, an acknowledgment message from at least the first node, the acknowledgment message acknowledging reception of the transmitted traffic announcement message and comprising the indication of the transmission time period.

In some aspects, the transmission scheduling manager 610 may receive an acknowledgement of the first message, or a trigger message, from at least the first node, the acknowledgement, or the trigger message, may include an indication of the reservation field. The direct wireless communication link may be a neighbor awareness network (NAN) direct link (NDL) and the identifier identifies the NDL. The identifier may be used by the one or more nodes of the NDL to facilitate transmissions during the transmission window and prevents out-of-network nodes from sending transmissions during the transmission window. The reservation field may include a network allocation vector (NAV). The transmission scheduling manager 610 may determine that at least one of the one or more nodes of the direct wireless communication link has transmitted a second message during the transmission window.

In some aspects, the transmission scheduling manager 610 may identify at least one parameter associated with a data transmission from a neighboring node during a third order of the data transmission window, the third order being prior to the second order, and determine a start time for the data transmission to at least the first node in the second order of the data transmission window.

The transmission controller 615 may monitor, control, or otherwise manage one or more aspects of controlling transmissions for the STA 115-r, as described above with reference to FIGS. 1-4. In some examples, the transmission controller 615 may transmit, to at least a first node of one or more nodes, a traffic announcement message in a first order during a paging window. The transmission controller 615 may transmit, to at least the first node, data in a second order during a data transmission window, the second order of the data transmission window corresponding to the first order of the paging window. In some aspects, the traffic announcement message may include the transmission time period. The traffic announcement message may include a transmission window start time for the data transmission to at least the first node in the second order of the data transmission window. The direct wireless communication link may be a neighbor awareness network (NAN) direct link (NDL).

In some aspects, the paging window may be associated with a time when the at least first node is awake, or in an active state, and monitoring for the traffic announcement message. The data transmission window may occur subsequent to the paging window.

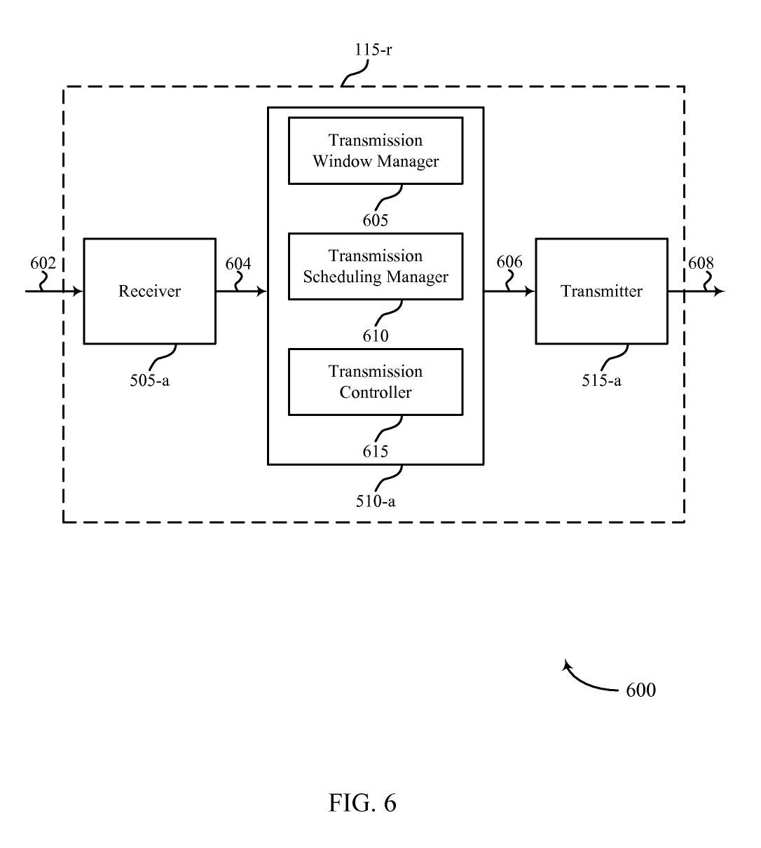

FIG. 7 shows a diagram of a system 700 for reducing contention in a P2P network or NDL in accordance with various aspects of the present disclosure. System 700 may include a STA 155-s, which may be an example of an STA or node 115 described above with reference to FIGS. 1-6. The STA 115-s may include a contention reduction manager 510-b, which may be an example of a contention reduction manager 510 described with reference to FIGS. 5-6. The STA 115-s may also include a communication management component 710. The STA 115-s may also include components for bi-directional voice and data communications including components for transmitting communications and components for receiving communications. For example, the STA 115-s may communicate bi-directionally with STA 115-t and/or another wireless communication device 105-a, such as an AP. The contention reduction manager 510-b may be configured to implement one or more of the contention reduction schemes described with reference to FIGS. 1-6.

The STA 115-s may also include a processor 705, and memory 715 (including software (SW)) 720, a transceiver 735, and one or more antenna(s) 740, which each may communicate, directly or indirectly, with each other (e.g., via buses 745). The transceiver 735 may communicate bi-directionally, via the antenna(s) 740 and/or wired or wireless links, with one or more networks, as described above. For example, the transceiver 735 may communicate bi-directionally with a wireless communication device 105 (such as an AP) and/or another STA 115. The transceiver 735 may include a modem to modulate the packets and provide the modulated packets to the antenna(s) 740 for transmission, and to demodulate packets received from the antenna(s) 740. While the STA 115-s may include a single antenna 740, the STA 115-s may also have multiple antennas 740 capable of concurrently transmitting and/or receiving multiple wireless transmissions.

The memory 715 may include random access memory (RAM) and read only memory (ROM). The memory 715 may store computer-readable, computer-executable software/firmware code 720 including instructions that, when executed, cause the processor 705 to perform various functions described herein (e.g., reducing contention in a P2P network, etc.). Alternatively, the software/firmware code 720 may not be directly executable by the processor 705 but cause a computer (e.g., when compiled and executed) to perform functions described herein. The processor 705 may include an intelligent hardware device, e.g., a central processing unit (CPU), a microcontroller, an ASIC, etc.

The communication management component 710 may manage one or more aspects of communications with other STAs 115 that employ the techniques for contention reduction described herein. For example, the communication management component 710 may communicate with the contention reduction manager 510-b to determine transmission window timing parameters, traffic announcement scheduling, and/or data transmission scheduling.

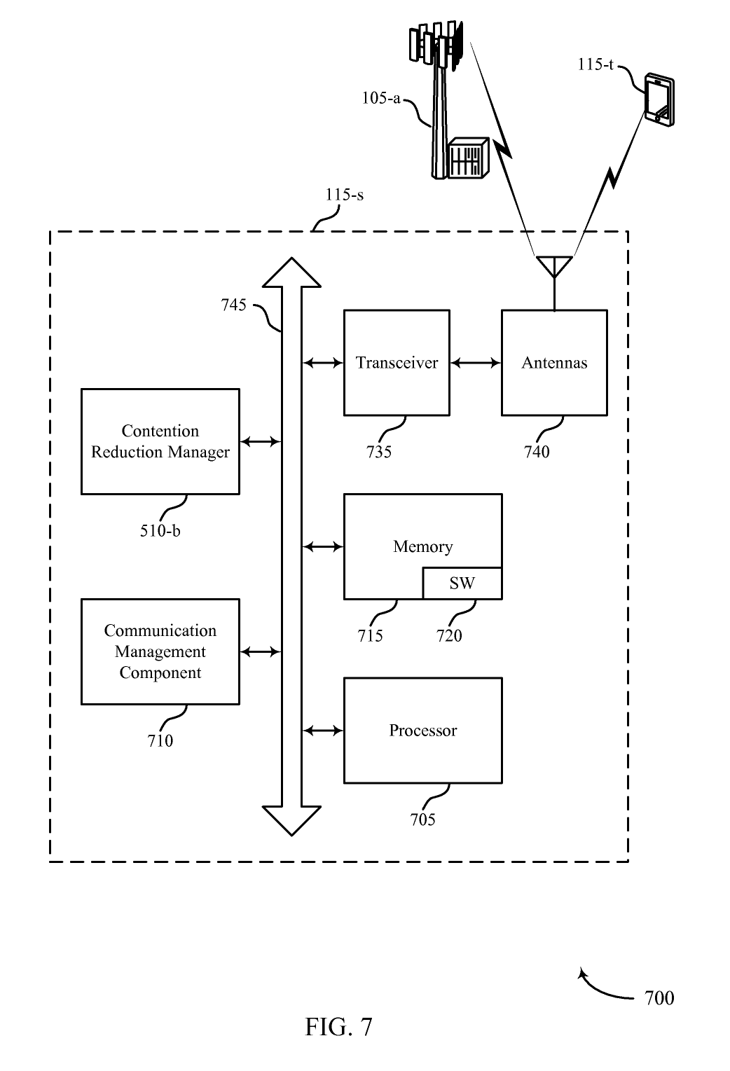

FIG. 8 shows a flowchart illustrating a method 800 for reducing contention in a P2P network or NDL in accordance with various aspects of the present disclosure. The operations of method 800 may be implemented by a STA 115 or its components as described with reference to FIGS. 1-7. In certain examples, the operations of method 800 may be performed by the contention reduction manager 510 as described with reference to FIGS. 5-7. In some examples, a STA 115 may execute a set of codes to control the functional elements of the STA 115 to perform the functions described below. Additionally or alternatively, the STA 115 may perform aspects the functions described below using special-purpose hardware.

At block 805, the STA 115 may transmit, to at least a first node of one or more nodes, a traffic announcement message in a first order during a paging window as described above with reference to FIGS. 2-4. In certain examples, the operations of block 805 may be performed by the contention reduction manager 510 as described above with reference to FIGS. 5 and 6.

At block 810, the STA 115 may transmit, to at least the first node, data in a second order during a data transmission window, the second order of the data transmission window corresponding to the first order of the paging window, as described above with reference to FIGS. 2-4. In certain examples, the operations of block 810 may be performed by the contention reduction manager 510 as described above with reference to FIGS. 5 and 6.

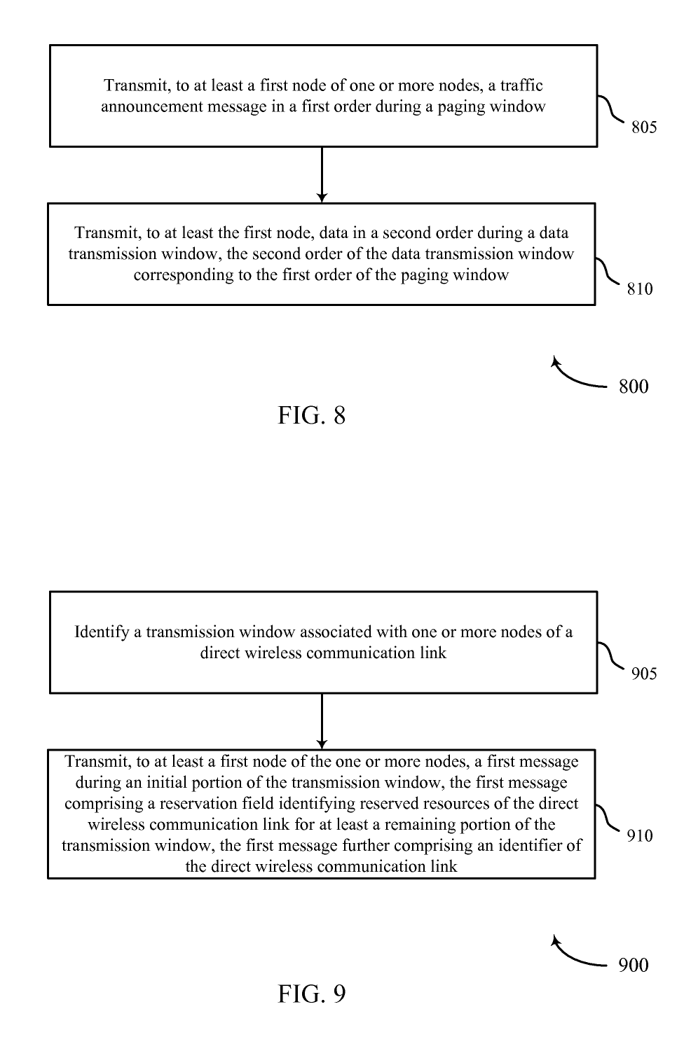

FIG. 9 shows a flowchart illustrating a method 900 for reducing contention in a P2P network or NDL in accordance with various aspects of the present disclosure. The operations of method 900 may be implemented by a STA 115 or its components as described with reference to FIGS. 1-7. In certain examples, the operations of method 900 may be performed by the contention reduction manager 510 as described with reference to FIGS. 5-7. In some examples, a STA 115 may execute a set of codes to control the functional elements of the STA 115 to perform the functions described below. Additionally or alternatively, the STA 115 may perform aspects the functions described below using special-purpose hardware.

At block 905, the STA 115 may identify a transmission window associated with one or more nodes of a direct wireless communication link, as described above with reference to FIGS. 2-4. In certain examples, the operations of block 905 may be performed by the contention reduction manager 510 as described above with reference to FIGS. 5 and 6.

At block 810, the STA 115 may transmit, to at least a first node of the one or more nodes, a first message during an initial portion of the transmission window, the first message comprising a reservation field identifying reserved resources of the direct wireless communication link for at least a remaining portion of the transmission window, the first message further comprising an identifier of the direct wireless communication link, as described above with reference to FIGS. 2-4. In certain examples, the operations of block 910 may be performed by the contention reduction manager 510 as described above with reference to FIGS. 5 and 6.

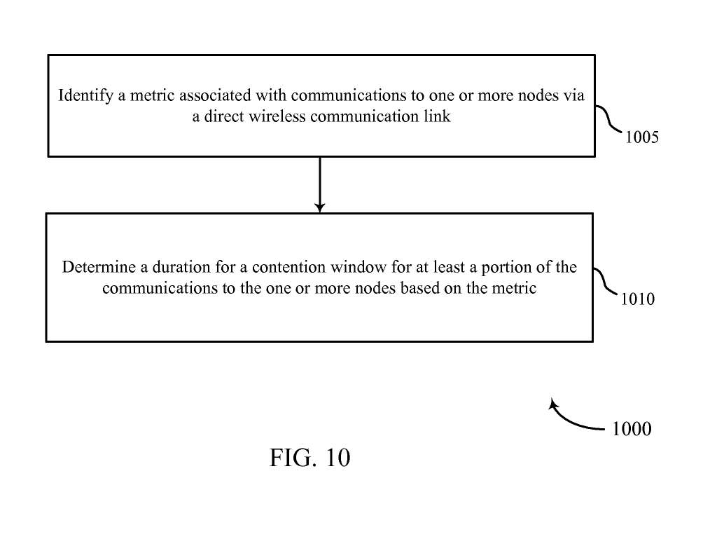

FIG. 10 shows a flowchart illustrating a method 1000 for reducing contention in a P2P network or NDL in accordance with various aspects of the present disclosure. The operations of method 1000 may be implemented by a STA 115 or its components as described with reference to FIGS. 1-7. In certain examples, the operations of method 1000 may be performed by the contention reduction manager 510 as described with reference to FIGS. 5-7. In some examples, a STA 115 may execute a set of codes to control the functional elements of the STA 115 to perform the functions described below. Additionally or alternatively, the STA 115 may perform aspects the functions described below using special-purpose hardware.

At block 1005, the STA 115 may identify a metric associated with communications to one or more nodes via a direct wireless communication link, as described above with reference to FIGS. 2-4. In certain examples, the operations of block 1005 may be performed by the contention reduction manager 510 as described above with reference to FIGS. 5 and 6.

At block 1010, the STA 115 may determine a duration for a contention window for at least a portion of the communications to the one or more nodes based on the metric, as described above with reference to FIGS. 2-4. In certain examples, the operations of block 1010 may be performed by the contention reduction manager 510 as described above with reference to FIGS. 5 and 6.

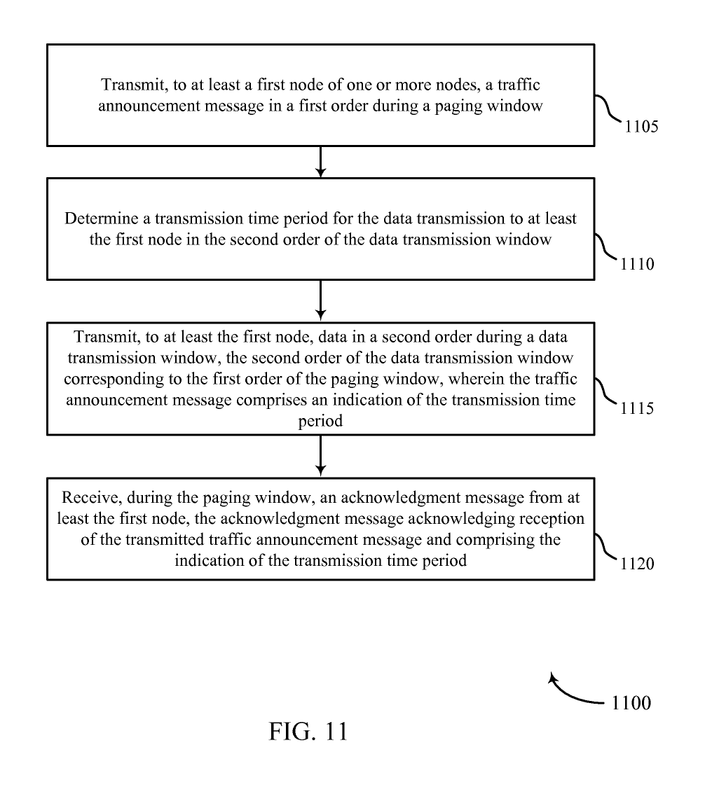

FIG. 11 shows a flowchart illustrating a method 1100 for reducing contention in a P2P network or NDL in accordance with various aspects of the present disclosure. The operations of method 1100 may be implemented by a STA 115 or its components as described with reference to FIGS. 1-7. In certain examples, the operations of method 1100 may be performed by the contention reduction manager 510 as described with reference to FIGS. 5-7. In some examples, a STA 115 may execute a set of codes to control the functional elements of the STA 115 to perform the functions described below. Additionally or alternatively, the STA 115 may perform aspects the functions described below using special-purpose hardware.

At block 1105, the STA 115 may transmit, to at least a first node of one or more nodes, a traffic announcement message in a first order during a paging window as described above with reference to FIGS. 2-4. In certain examples, the operations of block 1105 may be performed by the contention reduction manager 510 as described above with reference to FIGS. 5 and 6.

At block 1110, the STA 115 may determine a transmission time period for the data transmission to at least the first node in the second order of the data transmission window, as described above with reference to FIGS. 2-4. In certain examples, the operations of the block 1110 may be performed by the contention reduction manager 510 as described with reference to FIGS. 5 and 6.

At block 1115, the STA 115 may transmit, to at least the first node, data in a second order during a data transmission window, the second order of the data transmission window corresponding to the first order of the paging window, as described above with reference to FIGS. 2-4. In some cases, the traffic announcement message may comprise an indication of the transmission time period. In certain examples, the operations of block 1115 may be performed by the contention reduction manager 510 as described above with reference to FIGS. 5 and 6.

At block 1120, the STA 115 may receive, during the paging window, an acknowledgment message from at least the first node, the acknowledgment message acknowledging reception of the transmitted traffic announcement message and comprising the indication of the transmission time period, as described with reference to FIGS. 2-4. In certain examples, the operations of block 1115 may be performed by the contention reduction manager 510 as described above with reference to FIGS. 5 and 6.

Thus, methods 800, 900, 1000, and 1100 may provide for reducing contention in a P2P network or NDL. It should be noted that methods 800, 900, 1000, and 1100 describe possible implementation, and that the operations and the steps may be rearranged or otherwise modified such that other implementations are possible. In some examples, aspects from two or more of the methods 800, 900, 1000, and 1100 may be combined.

The detailed description set forth above in connection with the appended drawings describes exemplary embodiments and does not represent all the embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, a FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates a disjunctive list such that, for example, a list of [at least one of A, B, or C] means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, electrically erasable programmable read only memory (EEPROM), compact disk (CD) ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method for wireless communication, comprising:
transmitting, to at least a first node of one or more nodes, a traffic announcement message, indicating data pending for at least the first node, in a first order during a paging window; and
transmitting, to at least the first node, the data in a second order during a data transmission window, the second order of the data transmission window chronologically corresponding to the first order of the paging window.

2. The method of claim 1, further comprising:
identifying a metric associated with communications to one or more nodes via a direct wireless communication link; and
determining a duration for a contention window for at least a portion of the communications to the one or more nodes based on the metric.

3. The method of claim 2, wherein the contention window is associated with communications during the paging window and the metric is based at least in part on a count value of the one or more nodes communicating via the direct wireless communication link during the paging window.

4. The method of claim 2, wherein the contention window is associated with communications during the data transmission window and the metric is based at least in part on a count value of the one or more nodes communicating via the direct wireless communication link during the data transmission window.

5. The method of claim 2, wherein the metric is based at least in part on at least one of a duration of a timing interval associated with communications via the direct wireless communication link, a size of the traffic announcement message, a collision probability metric, a data type for the data transmission, or a priority value associated with the data transmission.

6. The method of claim 2, wherein the direct wireless communication link comprises a neighbor awareness network (NAN) direct link (NDL).

7. An apparatus for wireless communication, comprising:
a transmission controller for transmitting, to at least a first node of one or more nodes, a traffic announcement message, indicating data pending for at least the first node, in a first order during a paging window; and
the transmission controller for transmitting, to at least the first node, the data in a second order during a data transmission window, the second order of the data transmission window chronologically corresponding to the first order of the paging window.

8. The apparatus of claim 7, further comprising:
a transmission window manager for determining a transmission time period for the data transmission to at least the first node in the second order of the data transmission window.

9. The apparatus of claim 8, wherein the traffic announcement message comprises an indication of the transmission time period.

10. The apparatus of claim 8, further comprising:
a transmission scheduling manager for determining whether an acknowledgment of the traffic announcement message is received from at least the first node.

11. The apparatus of claim 10, wherein determining whether an acknowledgement of the traffic announcement message is received comprises:
receiving, during the paging window, an acknowledgment message from at least the first node, the acknowledgment message acknowledging reception of the transmitted traffic announcement message and comprising an indication of the transmission time period.

12. The apparatus of claim 8, wherein determining the transmission time period comprises:
identifying a communication metric associated with transmissions to at least the first node; and
determining an amount of data for transmission to at least the first node in the second order of the data transmission window.

13. The apparatus of claim 7, wherein the traffic announcement message comprises a transmission window start time for the data transmission to at least the first node in the second order of the data transmission window.

14. The apparatus of claim 7, further comprising:
a transmission scheduling manager for identifying at least one parameter associated with a data transmission from a neighboring node during a third order of the data transmission window, the third order being prior to the second order; and
the transmission scheduling manager for determining a start time for the data transmission to at least the first node in the second order of the data transmission window.

15. The apparatus of claim 7, wherein the data transmission window occurs subsequent to the paging window, and the paging window is at the beginning of a time block (TB) and is associated with a time when the at least first node is awake and at least one of monitoring for, or transmitting, the traffic announcement message.

16. The apparatus of claim 7, wherein the traffic announcement message is transmitted using an access category or the traffic announcement message comprises a traffic category, wherein at least one of the access category and the traffic category indicate a data type for the data transmission or a priority value associated with the data transmission.

17. A method for wireless communications, comprising:
identifying a transmission window associated with one or more nodes of a direct wireless communication link; and
transmitting, to at least a first node of the one or more nodes, a first message during an initial portion of the transmission window, the first message comprising a reservation field identifying reserved resources of the direct wireless communication link for at least a remaining portion of the transmission window, the first message further comprising an identifier of the direct wireless communication link.

18. The method of claim 17, wherein the transmission window comprises a paging window and the first message comprises a traffic announcement message, indicating data pending for at least the first node, and wherein the paging window is associated with a time when the at least first node is awake and at least one of monitoring for, or transmitting, the traffic announcement message.

19. The method of claim 17, wherein the transmission window comprises a data transmission window and the first message comprises a data transmission.

20. The method of claim 17, wherein the first message comprises a clear-to-send (CTS) message, the CTS message comprising a CTS-to-self field.

21. The method of claim 17, further comprising:
receiving an acknowledgement of the first message from at least the first node, the acknowledgement comprising an indication of the reservation field.

22. The method of claim 17, wherein the direct wireless communication link comprises a neighbor awareness network (NAN) direct link (NDL) and the identifier identifies the NDL.

23. The method of claim 22, wherein the identifier is used by the one or more nodes of the NDL to facilitate transmissions during the transmission window and prevents out-of-network nodes from sending transmissions during the transmission window.

24. An apparatus for wireless communications, comprising:
a transmission window manager for identifying a transmission window associated with one or more nodes of a direct wireless communication link; and
a transmission controller for transmitting, to at least a first node of the one or more nodes, a first message during an initial portion of the transmission window, the first message comprising a reservation field identifying reserved resources of the direct wireless communication link for at least a remaining portion of the transmission window, the first message further comprising an identifier of the direct wireless communication link.

25. The apparatus of claim 24, further comprising:
a transmission scheduling manager for determining that at least one of the one or more nodes of the direct wireless communication link has transmitted a second message during the transmission window.

26. The apparatus of claim 24, wherein the reservation field comprises a network allocation vector (NAV).

27. The apparatus of claim 24, further comprising:
the transmission window manager for identifying a metric associated with communications to the one or more nodes via the direct wireless communication link; and
the transmission window manager for determining a duration for a contention window for at least a portion of the communications to the one or more nodes based on the metric.

28. The apparatus of claim 27, wherein the contention window is associated with communications during a paging window and the metric is based at least in part on a count value of the one or more nodes communicating via the direct wireless communication link during the paging window.

29. The apparatus of claim 27, wherein the contention window is associated with communications during the transmission window and the metric is based at least in part on a count value of the one or more nodes communicating via the direct wireless communication link during the transmission window.

30. The apparatus of claim 27, wherein the metric is based at least in part on at least one of a duration of a timing interval associated with communications via the direct wireless communication link, a size of a traffic announcement message, a collision probability metric, a data type for the data transmission, or a priority value associated with the data transmission.
